(19) United States
(12) Patent Application Publication
(10) Pub. No.: US 2025/0287268 A1
(43) Pub. Date: Sep. 11, 2025

(54) SYSTEM, METHODS, USER EQUIPMENT AND BASE STATIONS FOR WIRELESS COMMUNICATION IN A NON-TERRESTRIAL NETWORK

(71) Applicant: Continental Automotive Technologies GmbH, Hannover (DE)

(72) Inventors: Andreas Andrae, Frankfurt am Main (DE); Rikin Shah, Langen (DE); Reuben George Stephen, Singapore (SG); David Gonzalez Gonzalez, Egelsbach (DE); Hojin Kim, Regensburg (DE)

(73) Assignee: Continental Automotive Technologies GmbH, Hannover (DE)

(21) Appl. No.: 18/860,013

(22) PCT Filed: Apr. 20, 2023
(86) PCT No.: PCT/EP2023/060338

§ 371 Date: Oct. 25, 2024

(30) Foreign Application Priority Data
Apr. 25, 2022 (DE) 10 2022 203 987.4

(51) Int. Cl. H04W 36/00; H04B 7/185; H04W 36/08

(52) U.S. Cl. CPC H04W 36/0016; H04B 7/18513; H04W 36/08

(57) ABSTRACT

In a handover process in non-terrestrial networks, a user equipment determines a mobility indicator representative of whether a relative velocity between the user equipment device and a serving base station is lower than a threshold, transmits the mobility indicator to the serving first base station, and completes handover to a second base station without random access procedure when the relative velocity is lower than the threshold.

### CROSS-REFERENCE TO RELATED APPLICATIONS

The present application is a National Stage Application under 35 U.S.C. § 371 of International Patent Application No. PCT/EP2023/060338 filed on Apr. 20, 2023, and claims priority from German Patent Application No. 10 2022 203 987.4 filed on Apr. 25, 2022, in the German Patent and Trademark Office, the disclosures of which are herein incorporated by reference in their entireties.

### TECHNICAL FIELD

The following relates generally to wireless communications, and more particularly to a method of improved handover in non-terrestrial networks.

### BACKGROUND

Wireless communication systems are widely deployed to provide various types of communication content such as voice, video, packet data, messaging, broadcast, and so on.

A wireless multiple-access communication system may include a number of base stations, each supporting communication for multiple mobile devices simultaneously. A base station may communicate with UEs on downstream and upstream links. Each base station has a coverage range, sometimes referred to as a cell coverage area.

Non-Terrestrial Networks (NTN) has become an umbrella term for any network that involves non-terrestrial flying objects, like satellites communication networks or High-Altitude Platforms Systems (HAPS) including airplanes, balloons and airships.

Satellite communication networks rely on spaceborne platforms comprising Low Earth orbiting (LEO) satellites, Medium Earth Orbiting (MEO) satellites, and geosynchronous Earth orbiting (GEO) satellites.

Nowadays, there is a growing interest in the broadband supported by LEO NTNs, with large satellites constellations. The satellite industry is now committed in the 3GPP process to integrate satellite networks into the 5G ecosystem.

The integration of Non-Terrestrial Networks (NTNs) within the 5G framework is under standardization and can lead to manifold advantages, such as wide service coverage capabilities (5G services for un- and underserved areas), reduced vulnerability of space/airborne vehicles to physical attacks and natural disasters, reinforced service reliability (service continuity for M2M/IoT devices or for passengers on board moving platforms, e.g., aircrafts or vessels, backup link), efficient multicast/broadcast for data delivery towards the network edges or even user terminals.

However, NTN integration is also leading to challenges related to the employment and adaptation to aerospace networks of technologies originally designed for terrestrial networks.

In particular, mobility NTN systems like LEO satellite systems, is somewhat different from terrestrial networks. In terrestrial networks, there are relatively small, fixed cells and moving UE, whereas in non-terrestrial networks, cells are moving along with satellites movements. In comparison, UE movements are slow and sometimes negligible.

Moreover, while UE move along any trajectories, LEO satellites move in a predictable manner, which makes it possible for a LEO satellite to estimate a target cell based on its own movement speed, direction and height from the ground, instead of relying on UE's measurement reports. Once the LEO satellite moves to a new cell, most (if not all) of the UEs will be handed over to the same target cell.

Considering the large cell size of non-terrestrial networks, many devices may be served within a single cell. Depending on constellation assumptions (e.g., propagation delay and satellite speed) and UE density, a potentially very large number of UEs may need to perform handover at a given time, leading to possibly large signaling overhead and high power consumption, as well as service continuity challenges.

There is therefore a need for a method of handover in a NTN network that reduce signaling overhead and associated energy consumption, which is particularly crucial for IoT devices.

### BRIEF SUMMARY

In accordance with an aspect of the disclosure, there is provided a wireless communication system comprising a first non-terrestrial base station serving at least one user equipment device, and a second non-terrestrial base station, wherein the user equipment device comprises a memory and a processor coupled to the memory and configured to:
Determine (S200) a mobility indicator representative of whether a relative velocity between the user equipment device and the first base station is lower than a threshold,
Transmit (S202) said mobility indicator to the first base station,
Complete handover (S209) to the second base station without random access procedure when said relative velocity is lower than said threshold, and wherein the first base station comprises a memory and a processor coupled to the memory and configured to:
Receive (S203) a mobility indicator representative of whether a relative velocity between the user equipment device and the first base station is lower than a threshold,
Transmit (S204) said mobility indicator to the second base station, along with an identifier of said user equipment device and an uplink grant configuration configured for said user equipment device in said first base station, and
   wherein the second base station comprises a memory and a processor coupled to the memory and configured to:
Receive (S205) a configuration from the first base station comprising at least a mobility indicator representative of whether a relative velocity between a user equipment device and the first base station is lower than a threshold, an identifier of said user equipment device and an uplink grant configuration configured for said user equipment device in said first base station,
Configure (S206) at least one grant resource according to said received configuration when received mobility indicator is representative of a velocity between said user equipment device and the first base station that is lower than said threshold.

Hence, a user equipment can provide indication on its mobility status to NTN cell(s). Thus, the network can handle low-motion/stationary and mobile user equipment differently: After handover, stationary/low mobility UEs can resume operations using resources previously granted, resulting in reduced signaling efforts and power consumption for low mobility/stationary IoT devices.

It is appreciable that the proposed system provides improved handover procedure and optimized UE energy consumption.

According to another aspect, it is proposed a method of wireless communication performed by a user equipment device in a non-terrestrial network comprising a first non-terrestrial base station serving said user equipment and a second non-terrestrial base station, the method comprising:
Determining (S200) a mobility indicator representative of whether a relative velocity computed between the user equipment device and the first base station is lower than a threshold,
Transmitting (S202) said mobility indicator to the first base station, and
Completing a handover (S209) to the second base station without random access procedure when said relative velocity is lower than said threshold.

According to an embodiment, computing a relative velocity between the user equipment device and the first base station comprises:
Determining a velocity of the user equipment relative to the ground,
Determining a velocity of the first base station relative to the ground,
Determining a projection of said velocity of the first base station onto plane of movement of said user equipment device,
Computing a ratio between said velocity of the user equipment and said projection of the velocity of the first base station,
Applying a scaling factor to the computed ratio depending on the relative orientation between user equipment and the first base station.

In accordance with an embodiment, the mobility indicator is transmitted to the second base station on a Dedicated Control Channel.

In accordance with an embodiment, the mobility indicator is transmitted to the second base station on a Physical uplink shared channel.

In accordance with an aspect of the disclosure, there is provided a user equipment device for wireless communication comprising a processor coupled to a memory in which computer program instructions are stored, the processor being configured by said instructions to perform the following steps:
Determining (S200) a mobility indicator representative of whether a relative velocity computed between the user equipment device and the first base station is lower than a threshold,
Transmitting (S202) said mobility indicator to the first base station, and
Completing a handover (S209) to the second base station without random access procedure when said relative velocity is lower than said threshold.

In accordance with a further aspect of the disclosure, there is provided a method of wireless communication performed by a first non-terrestrial target base station, the method comprising:
Receiving (S205) a configuration from a second non-terrestrial base station serving a user equipment comprising a mobility indicator representative of whether a relative velocity between said user equipment and said second base station is lower than a threshold, an identifier of said user equipment device and an uplink grant configuration configured for said user equipment in said second base station,
Configuring (S206) at least one grant resource according to said received configuration when received mobility indicator is representative of a velocity between said user equipment device and the second base station that is lower than said threshold.

According to an embodiment, the configuration received from the second non-terrestrial base station further comprises at least a Timing Advance (TA) value configured in the second base station for said user equipment device.

According to an embodiment, the configuration received from the second non-terrestrial base station is received through a Xn communication interface.

In accordance with an aspect of the disclosure, there is provided a non-terrestrial base station device comprising a processor coupled to a memory in which computer program instructions are stored, the processor being configured by said instructions to perform steps of:
Receiving (S205) a configuration from a second non-terrestrial base station serving a user equipment comprising a mobility indicator representative of whether a relative velocity between said user equipment and said second base station is lower than a threshold, an identifier of said user equipment device and an uplink grant configuration configured for said user equipment in said second base station,
Configuring (S206) at least one grant resource according to said received configuration when received mobility indicator is representative of a velocity between a user equipment device and the first base station that is lower than said threshold.

In accordance with another aspect of the disclosure, it is proposed a method of wireless communication performed by a first non-terrestrial base station serving a user equipment, the method comprising:
Receiving (S203) from said user equipment a mobility indicator representative of whether a relative velocity between said user equipment and said first base station is lower than a threshold,
Transmitting (S204) a configuration to a second non-terrestrial base station comprising at least said received mobility indicator, an identifier of said user equipment and an uplink grant configuration configured for said user equipment in said first base station.

The present disclosure further contemplates that said mobility indicator is received on a Dedicated Control Channel.

The present disclosure also contemplates that mobility indicator is received on a Physical Uplink Shared Channel.

In accordance with an aspect of the disclosure, it is provided a non-terrestrial base station device serving a user equipment comprising a processor coupled to a memory in which computer program instructions are stored, the processor being configured by said instructions to perform:
Receiving (S203) from said user equipment a mobility indicator representative of whether a relative velocity between said user equipment and said first base station is lower than a threshold,
Transmitting (S204) a configuration to a second non-terrestrial base station comprising at least said received mobility indicator, an identifier of said user equipment and an uplink grant configuration configured for said user equipment in said first base station.

In a particular embodiment, the various steps of the wireless communication method performed by a user equipment, of the wireless communication method performed by a serving base station and of the wireless communication method performed by a target base station are determined by instructions of computer programs.

Consequently, an embodiment of the present disclosure relates to computer programs on an information medium, these programs being suitable to be implemented respectively in user equipment and network node devices or more generally in a computer, these programs respectively comprising instructions adapted to implement the steps of the wireless communication methods respectively performed by a user equipment, serving base station and target base station which have just been described.

These programs can use any programming language, and be in the form of source code, object code, or of code intermediate between source code and object code, such as in a partially compiled form, or in any other desirable form.

A further aspect contemplates an information medium readable by a computer comprising instructions of a computer program such as mentioned hereinabove.

The information medium may be any entity or device capable of storing the program. For example, the medium can comprise a storage means, such as a ROM, for example a CD ROM or a microelectronic circuit ROM, FLASH memory or any magnetic recording means, for example a hard drive.

Moreover, the information medium may be a transmissible medium such as an electrical or optical signal, which may be conveyed via an electrical or optical cable, by radio or by other means. The program according to an embodiment of the invention may in particular be downloaded from a network.

Alternatively, the information medium may be an integrated circuit into which the program is incorporated, the circuit being adapted to execute or to be used in the execution of the methods in question.

The advantages of the user equipment, the serving base station and the target base stations, of the corresponding computer programs and information mediums are identical to those presented in relation with the corresponding method according to any one of the embodiments mentioned hereinabove.

### BRIEF DESCRIPTION OF THE DRAWINGS

Other advantages and characteristics of the invention will be more clearly apparent on reading the following description, given by way of simple illustrative and nonlimiting example, and the appended drawings.

FIG. 1 illustrates an exemplary LEO NTN that supports the wireless communications methods disclosed herein according to an embodiment.

FIG. 2 is a combined flow chart and signaling scheme that illustrates wireless communication methods for improved handover procedure between a user equipment, a source and a target base stations according to a particular embodiment.

FIG. 3 shows a MAC CE bitstring suitable to transmit a mobility indicator according to an embodiment.

FIG. 4 illustrates steps of a method of wireless communication implemented by a NTN base station according to an embodiment.

FIG. 5 illustrates steps of a method of wireless communication implemented by a user equipment according to an embodiment.

FIG. 6 is a block diagram showing an architecture of an apparatus suitable to implement a method of wireless communication performed by a user equipment according to an embodiment.

FIG. 7 is a block diagram showing an architecture of an apparatus suitable to implement a method of wireless communication performed by a target NTN base station, according to an embodiment.

FIG. 8 is a block diagram showing an architecture of an apparatus suitable to implement a method of wireless communication performed by a serving NTN base station, according to an embodiment.

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention.

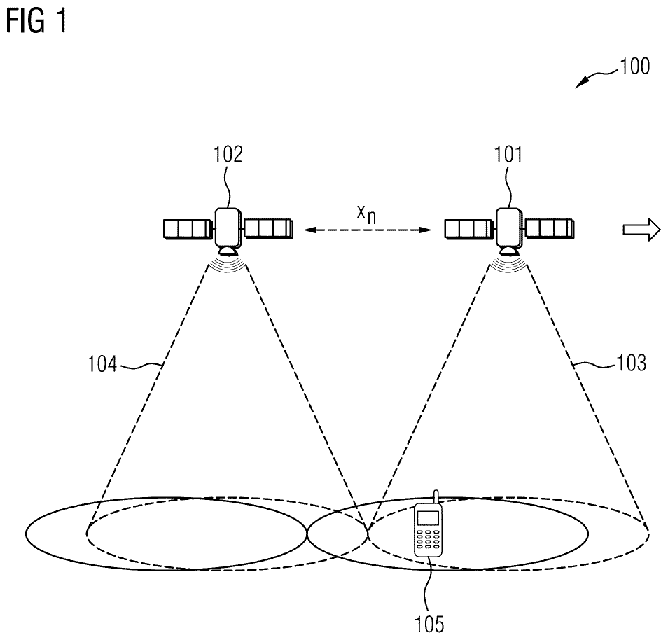

FIG. 1 shows an exemplary 5G New Radio (NR) wireless communication system 100 configured to support a handover procedure in a non-terrestrial network (NTN) in accordance with an embodiment of the disclosure.

The wireless system 100 comprises at least a first NTN base station 101 and a second NTN base station 102. In the example of FIG. 1, NTN base stations 101 and 102 are LEO satellites orbiting around the earth with known/or predictable orbital parameters. However, it is to be noted that base stations 101 and 102 could be of any High-Altitude Platforms Systems (HAPS) including airplanes, balloons, or airships, provided that such aerial platforms know its orbital parameters and those of neighboring nodes and can determine its future position and its distance from neighboring nodes. In some example, NTN base stations 101 and 102 are 5G NR base stations (gNodeB, or gNB).

FIG. 1 also shows a User Equipment (UE) device 105 initially served in a source cell by base station 101.

LEO satellites 101 and 102 are traveling along a predictable orbit at a constant speed relative to the earth's ground, for example at 7.56 km/s, thus making their respective radio beams 103 and 104 moving over time. UE 105, as well as other UE served in the same cell, is therefore frequently handed over to a new target cell. Considering the large cell size of NTN, a potentially very large number of UEs may thus need to perform handover at the same time, leading to large signaling overhead.

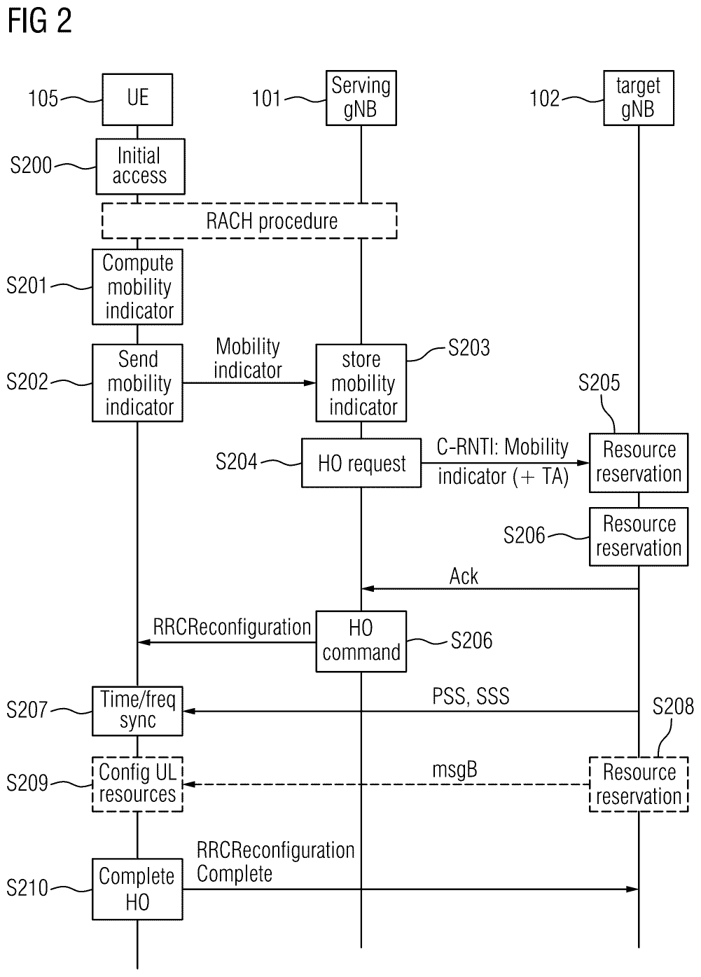

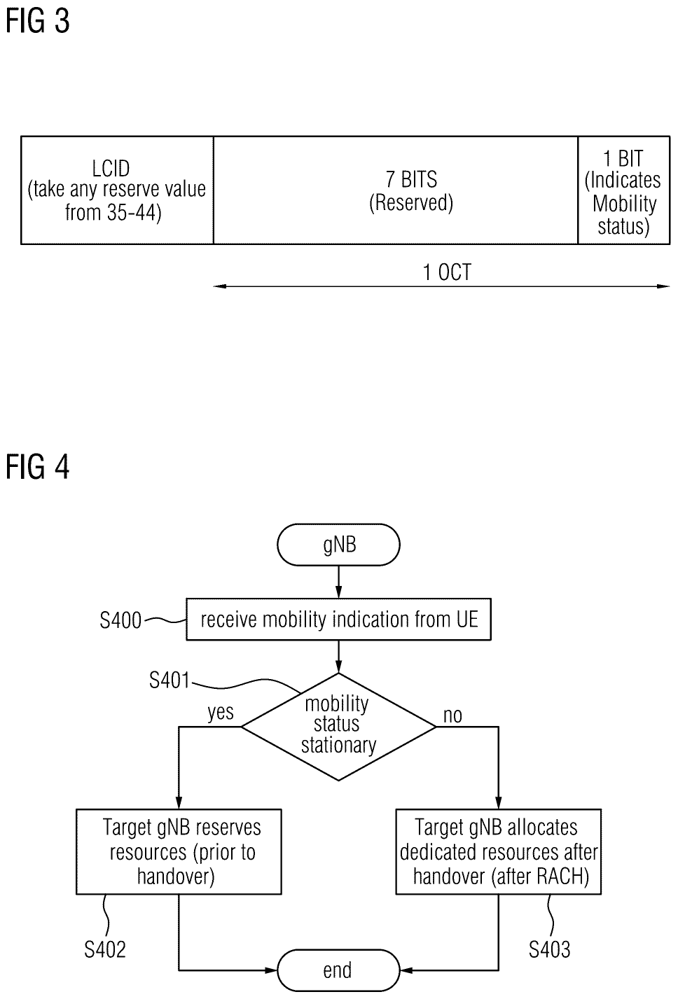

FIG. 2 is a combined flow chart illustrating a handover procedure between UE 105, source base station 101 and a target base station 102, wherein UE 105 is initially served in a source cell by base station 101 according to an embodiment.

FIG. 2 shows a first step S200 during which UE 105 perform initial network access in order to achieve uplink synchronization between UE and base station. The initial network access comprises at least a well-known Random Access procedure. Random Access procedure is performed by UE 105 using an uplink shared channel (RACH, Random Access Channel) in order to synchronize itself with the serving base station 101.

UE 105 initiates the Random Access procedure by randomly selecting a signature from a given set of signatures, and by transmitting a so-called preamble containing the selected signature to the base station 101. This preamble is also referred to as a “random access preamble”.

The base station 101 receives this preamble and uses it to determine some characteristics of the radio link with UE 105 (e.g. a Synchronization Timing Shift, i.e. a time difference for the synchronization between the UE and the base station that takes into account the signal propagation time between them).

The base station 101 then schedules an L2/L3 message, i.e. reserves resources for the UE 105 message transmission, and selects a C-RNTI (Cell Radio Network Temporary Identifier) for the UE 105. The base station 105 transmits a Preamble Response to the UE comprising the selected C-RNTI together with further information, e.g. for scheduling and for synchronization.

UE 105 stores the received scheduling information and transmits, using this information, a so-called L2/L3 message on the assigned radio resource. After the base station 101 has received the L2/L3 message and determined that no “errors” have occurred, it sends a so-called Contention Resolution to the UE 103. The UE 105 and the base station 101 are now synchronized.

UE 103 may be further configured to report information about the UE specific Timing Advance (TA) pre-compensation during Random Access procedure at Initial access. The UEs may also be configured to report information about the UE specific Timing Advance pre-compensation in connected mode. If not reported before, it may be reconfigured. The TA reporting trigger event uses an offset threshold between current information about UE specific TA and the last successfully reported information about UE specific TA.

In a further step S201, User Equipment 105 determines a so-called mobility indicator. In accordance with an embodiment of the disclosure, the mobility indicator may be a 1 bit flag representative of whether a relative velocity between UE 105 and the base station 101 is lower than a threshold.

According to an embodiment, the step of determining a mobility indicator includes computing, by the user equipment 105, a velocity of the user equipment relative to the ground. Determining velocity may include determining speed and direction of UE 103, using for example embedded sensor like gyroscope and/or accelerometer, GNSS (Global Navigation Satellite System) receiver, differences in received frequencies (reference signals of serving cell and neighboring cells), or in another example using a history of motion status.

According to an embodiment, the step S201 of determining a mobility indicator may further include determining a velocity of the serving base station 101, and/or a projection of said velocity onto plane of movement of UE 105. As an example, UE 105 may compute velocity of serving base station 103 using known ephemeris data.

The speed of the LEO satellite 101 is constant from the time of launch and known, and its absolute direction at a particular location on the earth and a particular time would also be fixed. The relative direction of the satellite 101 with respect to the UE 105 can be determined by the UE 103 based on its own location and orientation. The UE 105 may apply a suitable scaling to the predetermined threshold depending on its own direction relative to the serving satellite's.

According to an embodiment, UE 105 may compute a ratio ρ of its own velocity with that of the serving satellite 101:

$$ρ = \vert \frac{v cos α}{u} \vert$$

where v stands for the velocity of UE 105, u stands for projection of velocity of satellite onto plane of movement of UE and α is an angle between v and u, and where cos α is a scaling factor depending on the relative orientation between UE and satellite.

In accordance with an embodiment, UE 105 may further compare ρ with a threshold τ to determine whether to set the mobility indicator:
If ρ<τ, mobility indicator=0
If ρ≥τ, mobility indicator=1

The threshold τ may be pre-configured in the user equipment 105 or dynamically configured by the network (e.g., via system information). Threshold t may further be of a same value for a plurality of user equipment.

At step S202, UE 105 transmits the determined mobility indicator to the serving base station 101.

According to an embodiment, UE 105 sends the mobility indicator using an uplink control channel one RRC Connection has been established. For example, mobility indicator may be sent over a Dedicated Control Channel (DCCH) in an UEAssistanceInformation message as defined in 3GPP TS 38.331 standard document. As an example, UE 105 may add one bit representative of the mobility indicator value to the UEAssistanceInformation message field.

In some embodiment, UE 105 may send the mobility indicator over a Physical uplink shared channel (PUSCH) in MAC CE bit string. The MAC CE bitstring may be a Logical Channel ID (LCID) value for Uplink Shared Channel (UL-SCH). FIG. 4 shows an exemplary LCID value wherein one bit from the reserved 35-44 bit range is used to indicate the mobility status.

According to an embodiment, UE 105 sends such mobility indication when performing initial access at step S200.

In accordance with an embodiment, UE 105 sends such mobility indication periodically. For such purpose, it is proposed to introduce a new timer (e.g., periodicindication-Timer). When periodicindication-Timer expires, UE reports mobility indicator to serving base station. This periodicindication-Timer is restarted at UE after reporting mobility indicator. The max value of periodicGlobalModel-Timer can be set to “infinity” which means it can be disabled. The periodicindication-Timer starts when it reports mobility indicator during the initial access procedure performed at step S200.

In accordance with an embodiment the mobility indicator transmission may be triggered according to the UE mobility state/ego motion update detection.

At step S203, base station 101 receives the mobility status sent by UE 105 and stores the mobility status in association with an identifier of the user equipment 105, for example in association with the C-RNTI selected for UE 105 during initial RACH procedure. Base station 101 may also store UE specific Timing Advance (TA) pre-compensation received from the UE in association with C-RNTI value.

At step S204, the base station 101 initiates a handover to the target base station 102 by sending a handover request through Xn interface and provides the target base station with collected mobility status (referenced by C-RNTI) as well as TA value. More generally, the source base station 101 transmits to the target base station 102 a resource configuration comprising at least an uplink grant configuration configured in the source base station 101 for the UE 103, and the received mobility indicator. In some embodiment, the transmitted configuration may further comprise a Timing Advance (TA) parameter associated with UE 103.

During a step S205, upon receipt of the handover request and the configuration sent by the serving base station 101, when the mobility indicator indicates a stationary UE the target base station 102 prepares for handover by reserving/allocating radio resources indicated in the configuration received from the source base station 101 and configures an uplink grant accordingly. Indeed, low mobility or stationary UE employ more or less stable TA for uplink signaling. Therefore, the present disclosure contemplates that a target base station uses a same radio configuration as configured in the source base station for a stationary UE. The target base station 102 may then transmit a Handover Request Acknowledgment to the source base station 101.

Thus, as illustrated on FIG. 4, when a mobility indicator received (S400) by a serving base station indicates (S401) a stationary UE, target base station reserves (S402) resources prior to handover, whereas when said mobility indicator indicates (S401) a non-stationary UE, target base station allocates (S403) dedicated resources after an RACH procedure is performed by UE on target base station.

At step S206, the serving base station 101 instruts the UE 105 to perform a handover to target base station 102. To this end, base station 101 may send a handover command message (e.g., an RRCReconfiguration message) to UE 105 to instruct the UE to switch to a target cell.

UE 103 detects PSS (Primary Synchronization Signal) and SSS (Secondary Synchronization Signal) synchronization signals from target base station 102 during step S207 to achieve at least radio frame, subframe, slot and symbol synchronization in the time domain.

Because low mobility or stationary UE employ more or less stable TA for uplink signaling, and because the target base station 102 reserved radio resources according to the serving base station radio configuration, the present disclosure contemplates that UE 105 may not initiate RACH procedure to get synchronized with the target base station 102 when UE's mobility indicator indicates low-motion or stationary mobility status (e.g. mobility indicator=1). Uplink msgA signaling may therefore be avoided. On the other hand, when UE 105 has determined a mobility indicator that does not indicate a low-motion or stationary mobility status (e.g. low-mobility indicator=0), it may initiate an RACH procedure on the target base station and complete the handover process in a classical way.

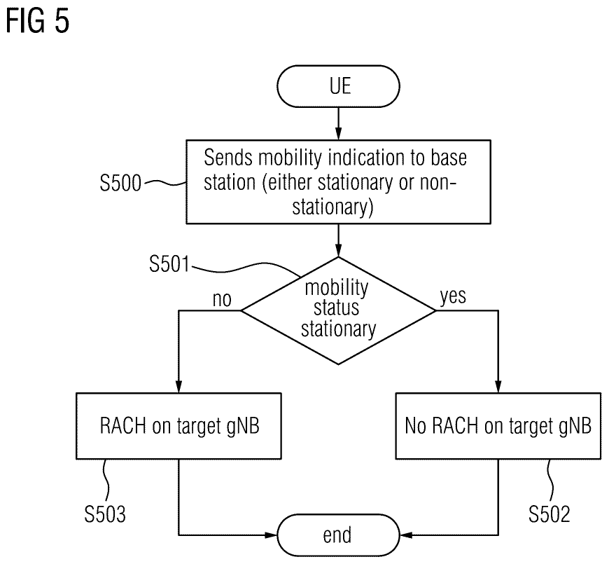

As shown in FIG. 5, when the mobility indication sent (S500) by the UE to its serving base station indicates (S501) a stationary UE, no RACH is performed (S502) on target base station, whereas when the mobility indication sent (S500) by the UE to its serving base station indicates (S501) a non-stationary UE, UE performs RACH (S503) on target base station.

According to an embodiment, target base station 102 may optionally send, at a step S208, a msgB message (including uplink grant as configured at step S205) to UE 105. In such case, UE 105 may then implement configuration of received uplink resources during a step S209.

In accordance with an embodiment, the target base station 102 may not send msgB message to UE 105 when the mobility indicator received from base station 101 indicates a low-motion or stationary UE and step S209 is not implemented by UE 103. Instead, UE 105 may resume operations using resources granted at initial access to the serving base station 101, such resources being still valid because low mobility or stationary UE employ more or less stable TA for uplink signaling. Moreover, in NTN context, UE can autonomously determine TA values on the basis of known satellite position, motion, and ephemeris data.

UE 105 ends the handover process by sending an RRCReconfiguraitonComplete to target base station 102 at step S210.

Hence, after handover, stationary/low mobility UEs can resume operations using same resources and potentially same C-RNTI, which results in a “transparent” handover. The novel method of handover disclosed herein advantageously reduce signaling overhead and energy consumption for low mobility or stationary UEs during handover.

On the other hand, mobile UE need to go through “normal” RACH procedure during which target base station will allocate dedicated resources.

According to an embodiment, a base station may use a mobility indicator to determine and configure UE's RRC state. Such mobility indication may help a base station to decide UE's RRC state and thus improve UE's energy consumption. For example, if a UE is indicated stationary, a base station may put UE into RRC inactive or RRC idle state.

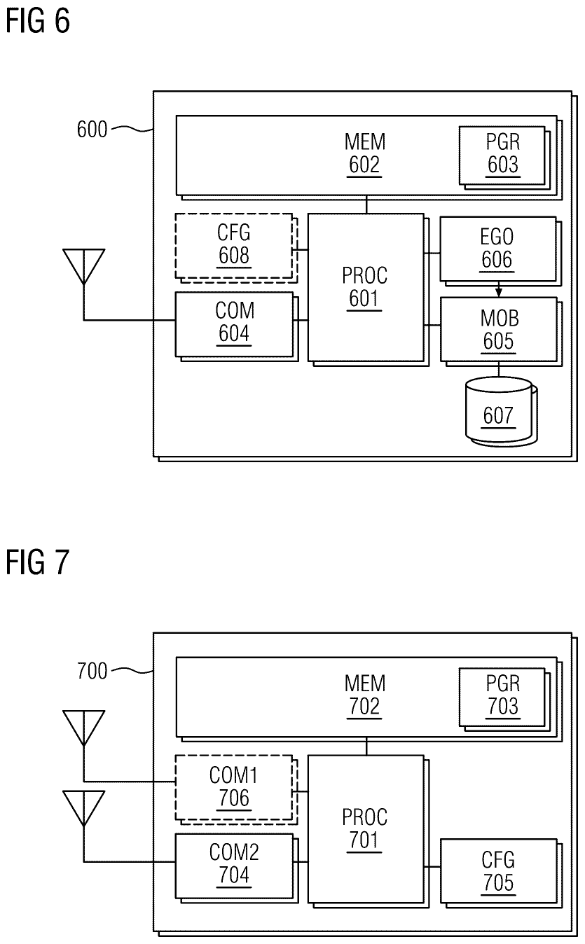

FIG. 6 shows a schematic architecture of an apparatus 600 suitable to implement a method of wireless communication for performing a handover by a user equipment device, according to an embodiment.

The apparatus 600 comprises a processor 601 and a memory 602, for example a Random Access Memory (RAM). The processor 601 may be controlled by a computer program 603 stored in the memory 602 comprising instructions configured to implement a method of wireless communication according to a particular embodiment.

More precisely, the computer program 603 comprises instructions to implement steps of:
Determining a mobility indicator representative of whether a relative velocity computed between the user equipment device and the first base station is lower than a threshold,
Transmitting said mobility indicator to the first base station, and
Completing a handover to the second base station without random access procedure when said relative velocity is lower than said threshold.

On initialization, the instructions of the computer program 603 may be loaded into the memory 602 before being executed by the processor 601. The processor 601 implements the steps of the method according to the instructions of the computer program 603.

The apparatus 600 advantageously comprise a mobility status determination unit 605 configured to determine whether the apparatus is stationary or non-stationary. The unit 605 may be configured by computer program instructions stored in memory 602 to acquire motion data from a motion sensor 606, for example an accelerometer and/or a gyroscope and/or a GNSS receiver unit and to process acquired data to set a mobility indicator flag when the relative motion of the apparatus with respect to a serving NTN base station is below a threshold. To achieve such a task, said computer program instructions may be further configured to access an ephemeris database 607 comprising ephemeris data of a set of NTN base stations, to obtain ephemeris data of a serving base station and to determine at least a speed and a direction of motion of said serving base station. Said computer program instructions may be further configured to compute a ratio between a velocity of the apparatus determined by motion sensor 606 and a velocity computed for the serving base station, to apply a scale factor to said ratio depending on the respective direction of said apparatus and said NTN serving base station and set the mobility indicator flag when the scaled ratio is below a dynamically configured or pre-configured threshold value.

According to an embodiment, the apparatus 600 may include a configuration unit 608 arranged to obtain a threshold value from a network node for use by the motion status determination unit 605.

The apparatus 600 further comprises a wireless transceiver unit 604 that may be configured by the processor to establish radio communication with other devices. As an example, the wireless transceiver 604 may be a 5G NR compliant transceiver suitable to establish communication with a 5G NR non-terrestrial access network. The transceiver unit 604 may be further configured by computer program instructions to transmit the mobility indicator determined by the motion determination unit 605 to a serving base station on a Dedicated Control Channel or a Physical Uplink Channel established with said serving base station.

The wireless transceiver unit 604 may be further configured to receive a handover command to a target NTN base station, to detect synchronization signals transmitted by the target base station, to check a value of a mobility indicator determined by the motion determination unit 605, and establish a synchronized communication with the target base station without RACH using resource granted by a former serving base station when the mobility indicator indicates a stationary motion status, and establish a synchronized communication with the target base station with RACH when the indicator indicates a non-stationary apparatus.

The apparatus 600 may be integrated in a IoT or user equipment device.

FIG. 7 shows a schematic architecture of an apparatus 700 suitable to implement a method of wireless communication for performing a handover by a target NTN base station, according to an embodiment.

The apparatus 700 comprises a processor 701 and a memory 702, for example a Random Access Memory (RAM). The processor 701 may be controlled by a computer program 703 stored in the memory 702 comprising instructions configured to implement a method of wireless communication according to a particular embodiment.

More precisely, the computer program 703 comprises instructions to implement steps of:
Receiving a configuration from a non-terrestrial base station serving a user equipment, said configuration comprising a mobility indicator representative of whether a relative velocity between said user equipment and said base station serving said user equipment is lower than a threshold, an identifier of said user equipment device and an uplink grant configuration configured for said user equipment in said serving base station,
Configuring at least one grant resource according to said received configuration when received mobility indicator is representative of a velocity between said user equipment device and the serving base station that is lower than said threshold.

On initialization, the instructions of the computer program 703 may be loaded into the memory 702 before being executed by the processor 701. The processor 701 implements the steps of the method according to the instructions of the computer program 703.

The apparatus 700 comprises a wireless transceiver unit 704 that may be configured by the processor to establish radio communication with other devices. The wireless transceiver 704 may be configured to establish communication channels with neighboring NTN base stations through Xn interface, and to receive a configuration from a neighboring base station serving a user equipment, said configuration comprising at least a mobility indicator representative of whether a relative velocity between said user equipment device and said neighboring base station is lower than a particular threshold, an identifier of said user equipment device and an uplink grant configuration configured for said user equipment device in said neighboring base station.

The apparatus 700 further includes a configuration unit 705 arranged to configure at least one grant resource according to said configuration received by communication unit 704 when received mobility indicator is representative of a velocity between said user equipment device and the serving base station that is lower than said threshold.

The apparatus 700 may also comprise a wireless transceiver unit 706 configured to establish a communication link with a user equipment device identified in the received configuration without RACH using grant configuration configured for said user equipment by the configuration unit 705 when the received mobility indicator indicates a stationary mobility status. The wireless transceiver 706 is further configured to allocate resource for said user equipment and establish a communication with RACH when the received mobility indicator indicates a non-stationary mobility status.

In accordance with an embodiment, the apparatus 700 is included in a base station, for example a 5G NR gNB of an aerial platform, like an LEO satellite.

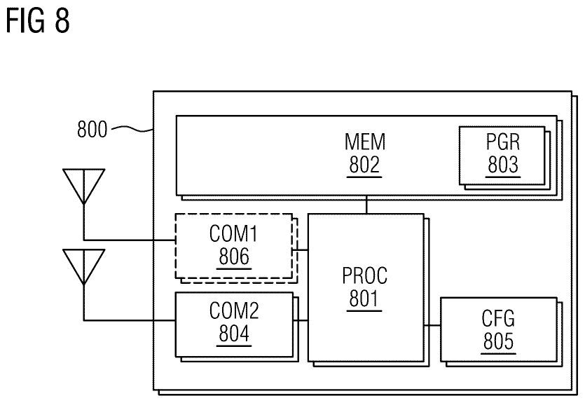

FIG. 8 shows a schematic architecture of an apparatus 800 suitable to implement a method of wireless communication for performing a handover by a NTN base station serving a user equipment, according to an embodiment.

The apparatus 800 comprises a processor 801 and a memory 802, for example a Random Access Memory (RAM). The processor 801 may be controlled by a computer program 803 stored in the memory 802 comprising instructions configured to implement a method of wireless communication according to a particular embodiment.

More precisely, the computer program 803 comprises instructions to implement steps of:
Receiving from a user equipment served by a base station including apparatus 800, at least a mobility indicator representative of whether a relative velocity between said user equipment and said base station serving said user equipment is lower than a threshold, and
Transmitting a configuration to a neighboring non-terrestrial base station comprising at least said received mobility indicator, an identifier of said user equipment and an uplink grant configuration configured for said user equipment in said serving base station.

On initialization, the instructions of the computer program 803 may be loaded into the memory 802 before being executed by the processor 801. The processor 801 implements the steps of the method according to the instructions of the computer program 803.

The apparatus 800 comprises a wireless transceiver unit 804 that may be configured by the processor to establish radio communication with other devices. In particular, the transceiver unit 804 may be configured to receive from a user equipment served by a base station in which apparatus 800 is included, at least a mobility indicator representative of whether a relative velocity between said user equipment and said base station serving said user equipment is lower than a threshold. In some examples, the wireless transceiver 804 may be a 5G NR compliant transceiver suitable to establish communication with a 5G NR compliant user equipment and to receive a message comprising at least said mobility indicator on a Dedicated Control Channel or a Physical Uplink Channel.

The apparatus 800 may further comprise a configuration unit 805 configured to store said mobility indicator received by the wireless transceiver unit 804. In particular, the configuration unit stores said mobility indicator in association with an identifier of the user equipment, for example in association with a C-RNTI selected for the user equipment.

The apparatus 800 may further comprise a wireless transceiver unit 806 that may be configured by the processor to establish radio communications with neighboring NTN base stations through Xn interface, and to send a configuration to a neighboring target base station, said configuration comprising at least said mobility indicator stored by the configuration unit 805.

In an embodiment, the apparatus 800 is included in an NTN serving base station.

1. A wireless communication system comprising a first non-terrestrial base station serving at least one user equipment device, and a second non-terrestrial base station, wherein the user equipment device comprises a memory and a processor coupled to the memory and configured to:
Determine a mobility indicator representative of whether a relative velocity between the user equipment device and the first base station is lower than a threshold,
Transmit said mobility indicator to the first base station,
Complete handover to the second base station without random access procedure when said relative velocity is lower than said threshold, and
wherein the first base station comprises a memory and a processor coupled to the memory and configured to:
Receive a mobility indicator representative of whether a relative velocity between the user equipment device and the first base station is lower than a threshold,
Transmit said mobility indicator to the second base station, along with an identifier of said user equipment device and an uplink grant configuration configured for said user equipment device in said first base station, and
wherein the second base station comprises a memory and a processor coupled to the memory and configured to:
Receive a configuration from the first base station comprising at least a mobility indicator representative of whether a relative velocity between the user equipment device and the first base station is lower than a threshold, an identifier of said user equipment device and an uplink grant configuration configured for said user equipment device in said first base station,
Configure at least one grant resource according to said received configuration when received mobility indicator is representative of a velocity between said user equipment device and the first base station that is lower than said threshold.

2. A method of wireless communication performed by a user equipment device in a non-terrestrial network comprising a first non-terrestrial base station serving said user equipment and a second non-terrestrial base station, the method comprising:
Determining a mobility indicator representative of whether a relative velocity computed between the user equipment device and the first base station is lower than a threshold,
Transmitting said mobility indicator to the first base station, and
Completing a handover to the second base station without random access procedure when said relative velocity is lower than said threshold.

3. The method according to claim 2, wherein computing a relative velocity between the user equipment device and the first base station comprises:
Determining a velocity of the user equipment relative to the ground,
Determining a velocity of the first base station relative to the ground,
Determining a projection of said velocity of the first base station onto plane of movement of said user equipment device,
Computing a ratio between said velocity of the user equipment and said projection of the velocity of the first base station,
Applying a scaling factor to the computed ratio depending on the relative orientation between the user equipment and the first base station.

4. The method according to claim 2, wherein the mobility indicator is transmitted to the second base station on a Dedicated Control Channel.

5. The method according to claim 2, wherein the mobility indicator is transmitted to the second base station on a Physical uplink shared channel.

6. A user equipment device for wireless communication comprising a processor coupled to a memory in which computer-executable instructions are stored, wherein the computer-executable instructions, when executed by the processor, cause the processor to perform operations in a non-terrestrial network comprising a first non-terrestrial base station, serving said user equipment and a second non-terrestrial base station, the operations comprising:
Determining a mobility indicator representative of whether a relative velocity computed between the user equipment device and the first base station is lower than a threshold,
Transmitting said mobility indicator to the first base station, and
Completing a handover to the second base station without random access procedure when said relative velocity is lower than said threshold.

7. Method of wireless communication performed by a first non-terrestrial target base station, the method comprising:
Receiving a configuration from a second non-terrestrial base station serving a user equipment, the configuration comprising a mobility indicator representative of whether a relative velocity between said user equipment and said second base station is lower than a threshold, an identifier of said user equipment device and an uplink grant configuration configured for said user equipment in said second base station,
Configuring at least one grant resource according to said received configuration when received mobility indicator is representative of a velocity between said user equipment device and said serving base station that is lower than said threshold.

8. The method according to claim 7 wherein the received configuration further comprises a timing advance parameter configured in the second base station for said user equipment device.

9. The method according to claim 7 wherein the configuration is received through an Xn communication interface.

10. A non-terrestrial base station device comprising a processor coupled to a memory in which computer-executable instructions are stored, wherein the computer-executable instructions, when executed by the processor cause the processor to perform operations comprising:
Receiving a configuration from a second non-terrestrial base station serving a user equipment, the configuration comprising a mobility indicator representative of whether a relative velocity between said user equipment and said second base station is lower than a threshold, an identifier of said user equipment device and an uplink grant configuration configured for said user equipment in said second base station,
Configuring at least one grant resource according to said received configuration when received mobility indicator is representative of a velocity between said user equipment device and said serving base station that is lower than said threshold.

11. A method of wireless communication performed by a first non-terrestrial base station serving a user equipment, the method comprising:
Receiving from said user equipment a mobility indicator representative of whether a relative velocity between said user equipment and said first base station is lower than a threshold,
Transmitting a configuration to a second non-terrestrial base station comprising at least said received mobility indicator, an identifier of said user equipment and an uplink grant configuration configured for said user equipment in said first base station.

12. The method according to claim 11, wherein said mobility indicator is received on a Dedicated Control Channel.

13. The method according to claim 11, wherein the mobility indicator is received on a Physical Uplink Shared Channel.

14. A non-terrestrial base station device comprising a processor coupled to a memory in which computer-executable instructions are stored, wherein the computer-executable instructions, when executed by the processor, cause the processor to perform operations comprising:
Receiving from a user equipment a mobility indicator representative of whether a relative velocity between said user equipment and said first base station is lower than a threshold,
Transmitting a configuration to a second non-terrestrial base station comprising at least said received mobility indicator an identifier of said user equipment and an uplink grant configuration configured for said user equipment in said first base station.

15. The method according to claim 3, wherein the mobility indicator is transmitted to the second base station on a Dedicated Control Channel.

16. The method according to claim 3, wherein the mobility indicator is transmitted to the second base station on a Physical uplink shared channel.
